(19) United States
(12) Patent Application Publication
(10) Pub. No.: US 2016/0035040 A1
(43) Pub. Date: Feb. 4, 2016

(54) SYSTEM AND METHOD OF DETERMINING AND OPTIMIZING HEALTHCARE SAVINGS OPPORTUNITIES FOR INDIVIDUALS VIA ALTERNATIVE ENGAGEMENT CHANNELS

(71) Applicant: CIGNA INTELLECTUAL PROPERTY, INC., WILMINGTON, DE (US)

(72) Inventors: JEFFREY A. YOUNG, OAKHAM, MA (US); AMY ELIZABETH BERESKY, WINDSOR, CT (US)

(21) Appl. No.: 14/817,171

(22) Filed: Aug. 3, 2015

Related U.S. Application Data
(60) Provisional application No. 62/032,807, filed on Aug. 4, 2014.

(51) Int. Cl. G06Q 40/08; G06Q 50/22; G06Q 30/02

(52) U.S. Cl. CPC G06Q 40/08; G06Q 30/0204; G06Q 50/22

(57) ABSTRACT

A system and method is provided for determining healthcare savings opportunities for individuals and the likelihood of achieving those savings via alternative engagement channels (or modalities) to optimize clinical (outreach) coaching opportunities. A potential cost savings associated with a targeted change (or coaching opportunity) of a customer may be determined. First and second probabilities of achieving a goal (that corresponds to the targeted change) when first and second modalities are used, respectively, to engage the customer to assist the customer in achieving the goal may be determined. A first score associated with the first modality and the goal may be determined based on the potential cost savings and the first probability. A second score associated with the second modality and the goal may be determined based on the potential cost savings and the second probability. Either the first modality or the second modality is selected as a selected modality based on a comparison of the first score and the second score for use in engaging the customer to assist the customer in achieving the goal.

### CROSS-REFERENCE TO RELATED APPLICATION

This application claims the benefit of U.S. Provisional Patent Application Ser. No. 62/032,807, filed Aug. 4, 2014, which is hereby incorporated by reference herein in its entirety.

### FIELD OF THE INVENTION

The invention relates generally to the field of health insurance, and more particularly to a system and method of determining healthcare savings opportunities for individuals and the likelihood of achieving those savings via alternative engagement channels (or modalities) to optimize clinical (outreach) coaching opportunities.

### BACKGROUND OF THE INVENTION

Health insurance providers provide health insurance (health, life, accident, medical, dental, disability, etc.) and other related products and services to individuals, typically through their employers (or other groups).

To assist customers in making better health and lifestyle choices, many health insurance providers engage in various clinical outreach programs and health promotion activities. Such efforts may include, for example, proactively engaging individuals who may be at risk for developing future health problems, helping individuals manage chronic conditions, and otherwise providing individuals with valuable tools and resources to help them achieve and maintain a healthy lifestyle.

Health insurance providers are incentivized to conduct these types of outreach campaigns at least in part because keeping their customers healthy can help reduce claims and curb premium hikes, among other benefits.

Unfortunately, many outreach programs and health promotion activities are not as successful as they could be due to a number of factors including, for instance, difficulty in identifying the most effective and impactful way to engage customers, as well as low levels of compliance by customers with targeted (or prescribed) activities.

These and other drawbacks exist with many clinical outreach efforts.

### SUMMARY OF THE INVENTION

The invention addressing these and other drawbacks relates to a system and method of determining healthcare savings opportunities for individuals and the likelihood of achieving those savings via alternative engagement channels (or modalities) to optimize clinical (outreach) coaching opportunities.

According to an aspect of the invention, a potential cost savings (or value) associated with a targeted change (or coaching opportunity, or intervention) of a customer may be determined.

A targeted change of a customer may, for example, comprise a behavior change of the customer, a physical change of the customer, or other change of (or associated with) a customer. Non-limiting examples of a targeted change may include, for instance, smoking cessation, a switch from a brand name to generic prescription drug medication, etc.

A potential cost savings (or value) associated with a targeted change may comprise a monetary or non-monetary cost savings. The potential cost-savings may benefit a health insurance provider that is insuring the customer, a current or prospective employer of the customer, the customer himself, or another entity or individual.

In one implementation, each targeted change may have an associated goal. For example, if a targeted change comprises smoking cessation, the associated goal may comprise a one-hundred percent (100%) reduction in smoking A targeted change may have a number of possible, associated goals (e.g., a 75% reduction in smoking, a 50% reduction in smoking, etc.). The nature and number of possible goals may vary depending on the targeted change.

According to an aspect of the invention, a probability of success (e.g., likelihood that a customer will change his or her behavior) of achieving a goal that corresponds to the targeted change may be determined for one or more modalities.

A modality (or engagement or communication channel) may comprise, without limitation, an interactive web/online application mode (e.g., automated web interaction, person-to-person chats, person-to-person video conference, a SKYPE™ session, etc.), an interactive telephonic mode (e.g., automated telephonic interaction, telephonic person-to-person interaction, etc.), an in-person mode (e.g., in-person meetings), or other modality by which a personal health coach, clinician, agent of the health insurance provider, or other individual may communicate with a customer.

In certain implementations, scores associated with one or more different modalities of engaging a customer (for facilitating a targeted change) may be determined. The scores may, for example, be determined based on a potential cost savings of the targeted change, respective probabilities of a goal (corresponding to the targeted change) being achieved when the associated modalities are used to facilitate the targeted change, or other criteria.

For example, a first score associated with a first modality and a given goal may be determined based on the potential cost savings and a first probability of success (based on engagement via the first modality). A second score associated with a second modality for the given goal may be determined based on the potential cost savings and a second probability of success (based on engagement via the second modality). Upon comparison of the scores, at least one of the modalities may be selected and indicated (or presented) to a personal health coach, clinician, agent of the health insurance provider, or other individual as the most effective (or impactful) way to assist the customer in achieving the corresponding goal. In another implementation, the selected modality may be presented to the customer so as to guide the customer in helping to select the most effective modality.

In some implementations, a score may reflect an assessment of a potential reward for achieving a goal and the probabilities of obtaining the reward. Thus, scores may be presented along with suggested modalities of engagement to convey the assessed values of adopting the system suggestions.

In some implementations, scores associated with one or more different modalities of engaging a customer (for facilitating a targeted change) may be determined for a single customer, or for one or more groups of customers. A group may comprise individuals sharing one or more common attributes (e.g., known smokers, known smokers of a given sex, known smokers of a given sex and age range, etc.). A group may also comprise a collection of individuals associated with a particular client of a health insurance provider (e.g., employees of a company or organization that provides health insurance through the health insurance provider). Scores may be generated across any group of individuals satisfying any number of predetermined criteria. In this way, based on determined scores, individuals or groups of individuals may be prioritized for inclusion in outreach or clinical coaching programs (e.g., individuals having a predetermined score may be flagged as “high risk” and contacted before individuals having scores that do not meet or exceed the predetermined score). Numerous implementations are possible.

Various other aspects, features, and advantages of the invention are described in detail herein, and will be apparent through the detailed description of the invention and the drawings attached hereto. It is also to be understood that both the foregoing general description and the following detailed description are exemplary and not restrictive of the scope of the invention. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 is an exemplary illustration of a system for providing indications of modalities for targeted customer changes, according to an aspect of the invention.

FIG. 2 is an exemplary illustration of a user interface that provides scores associated with respective modalities for facilitating a targeted change, according to an aspect of the invention.

FIG. 3 is an exemplary illustration of a user interface that provides a list of opportunities for a customer along with a suggested modality and an associated score for each opportunity, according to an aspect of the invention.

FIG. 4 is an exemplary illustration of a flowchart of a method of providing indications of modalities for targeted customer changes, according to an aspect of the invention.

FIG. 5 is an exemplary illustration of a flowchart of a method of determining probabilities of a customer achieving a goal corresponding to a targeted change when particular modalities of engagement are used based on whether the customer achieved corresponding goals of related changes that were previously targeted for the customer, according to an aspect of the invention.

FIG. 6 is an exemplary illustration of a flowchart of a method of determining probabilities of a customer achieving a goal corresponding to a targeted change when particular modalities of engagement are used based on whether other customers similar to the customer achieved corresponding goals of related changes that were previously targeted for the similar customers, according to an aspect of the invention.

### DETAILED DESCRIPTION OF THE INVENTION

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known structures and devices are shown in block diagram form in order to avoid unnecessarily obscuring the implementations of the invention.

The invention is directed to a system and method of determining healthcare savings opportunities for individuals and the likelihood of achieving those savings via alternative engagement channels (or modalities) to optimize clinical (outreach) coaching opportunities.

In one implementation, the system and method of the invention as described herein may be carried out by (or at the direction of) a health insurance provider for its benefit and/or the benefit of its clients and/or customers, or by another entity.

As used herein, a “health insurance provider” may comprise an entity that provides health insurance (health, life, accident, medical, dental, disability, etc.) and other related products and services to individuals, typically through their employers (or other groups).

As used herein, a “client” of the health insurance provider may comprise an employer, group, or other entity that contracts with the healthcare insurance provider to provide healthcare insurance to its employees or members.

As used herein, a “customer” of the health insurance provider may comprise an individual, insured person (e.g., an employee of a client). As such, the term “customer” may be used interchangeably with “consumer,” “employee,” “individual,” “insured,” “user,” or other similar descriptor. In some instances a customer may also be considered a client if he or she contracts directly with the health insurance provider for health insurance.

As used herein, a “coach” may comprise a personal health coach, doctor, nurse, counselor, agent of the health insurance provider or other entity, or other medical professional or individual that engages a customer via a particular modality as part of an outreach program, health promotion activity, or other campaign to help the customer achieve a targeted change.

While the features and functionality of the invention are explained herein in the exemplary context of the health insurance field, it should be appreciated that the system and method of the invention may be adapted for use in fields other than the field of health insurance. As such, the detailed description and accompanying drawing figures should not be viewed as limiting.

Exemplary System Description

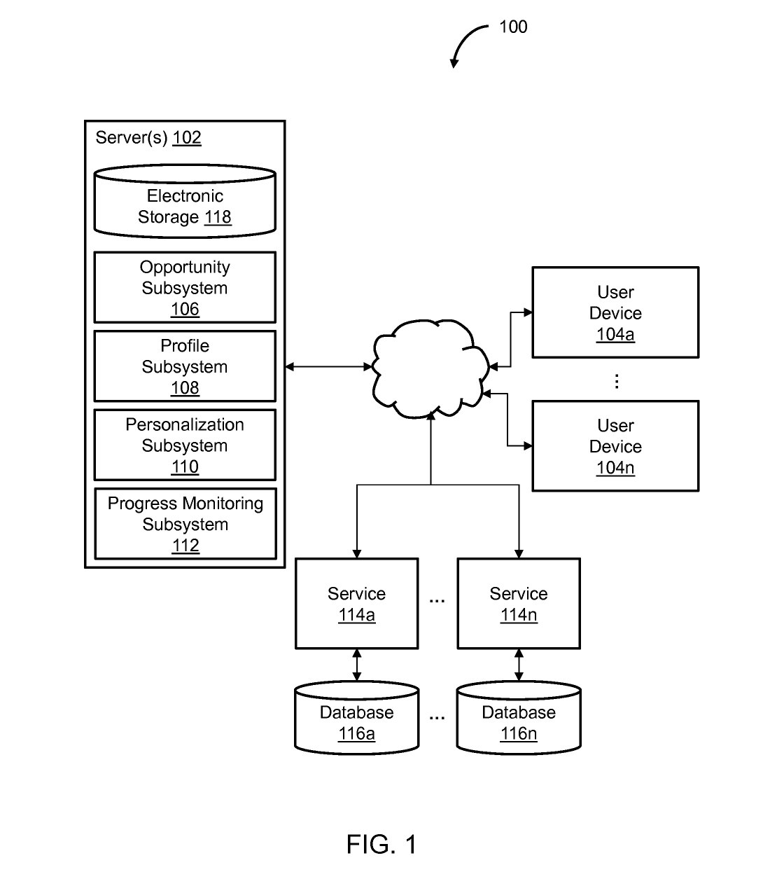

FIG. 1 is an exemplary illustration of a system 100 for providing indications of modalities for targeted customer changes, according to an aspect of the invention.

As shown in FIG. 1, system 100 may comprise server 102 (or multiple servers 102). Server 102 may comprise opportunity subsystem 106, profile subsystem 108, personalization subsystem 110, progress monitoring subsystem 112, or other components. In one implementation, server 102 may be operated and/or maintained by (or at the direction of) a health insurance provider, or by another entity.

System 100 may further comprise a user device 104 (or multiple user devices 104a-104n). User device 104 may comprise any type of mobile terminal, fixed terminal, or other device. By way of example, user device 104 may comprise a desktop computer, a notebook computer, a netbook computer, a tablet computer, a smartphone, a navigation device, an electronic book device, a gaming device, or other user device. Users may, for instance, utilize one or more user devices 104 to interact with server 102, one or more services 114a-114n, or other components of system 100. In one implementation, users may comprise employees or agents of the health insurance provider, as well as clients, customers, coaches, or other users.

It should be noted that while one or more operations are described herein as being performed by components of server 102, those operations may, in some implementations, be performed by components of user device 104.

In some implementations, the various computers and subsystems illustrated in FIG. 1 may comprise one or more computing devices that are programmed to perform the functions described herein. The computing devices may include one or more electronic storages (e.g., databases 116, electronic storage 118, or other electric storages), one or more physical processors programmed with one or more computer program instructions, and/or other components. The computing devices may include communication lines, or ports to enable the exchange of information with a network or other computing platforms. The computing devices may include a plurality of hardware, software, and/or firmware components operating together to provide the functionality attributed herein to the servers. For example, the computing devices may be implemented by a cloud of computing platforms operating together as the computing devices.

The electronic storages may comprise non-transitory storage media that electronically stores information. The electronic storage media of the electronic storages may include one or both of system storage that is provided integrally (e.g., substantially non-removable) with the servers or removable storage that is removably connectable to the servers via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information received from the servers, information received from client computing platforms, or other information that enables the servers to function as described herein.

The processors may be programmed to provide information processing capabilities in the servers. As such, the processors may include one or more of a digital processor, an analog processor, a digital circuit designed to process information, an analog circuit designed to process information, a state machine, and/or other mechanisms for electronically processing information. In some implementations, the processors may include a plurality of processing units. These processing units may be physically located within the same device, or the processors may represent processing functionality of a plurality of devices operating in coordination. The processors may be programmed to execute computer program instructions to perform functions described herein of subsystems 106, 108, 110, 112, or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 106, 108, 110, or 112 described herein is for illustrative purposes, and is not intended to be limiting, as any of subsystems 106, 108, 110, or 112 may provide more or less functionality than is described. For example, one or more of subsystems 106, 108, 110, or 112 may be eliminated, and some or all of its functionality may be provided by other ones of subsystems 106, 108, 110, or 112. As another example, additional subsystems may be programmed to perform some or all of the functionality attributed herein to one of subsystems 106, 108, 110, or 112.

Attention will now be turned to a more detailed description of various implementations comprising one or more features related to providing indications of modalities for targeted customer changes. It should be noted that features described herein may be implemented separately or in combination with one another.

Indications of Modalities for Targeted Customer Changes

According to an aspect of the invention, personalization subsystem 110 may be programmed to provide indications of modalities for facilitating one or more targeted changes for a customer.

As previously noted, a targeted change (or coaching opportunity, or intervention) of a customer may comprise a behavior change of the customer, a physical change of the customer, or other change of (or associated with) a customer. Non-limiting examples of a targeted change may include, for instance, smoking cessation, a switch from a brand name to generic prescription drug medication, etc.

A modality (or engagement or communication channel) may, for example, comprise an interactive web/online application mode (e.g., automated web interaction, person-to-person chats, person-to-person video conference, a SKYPE™ session, etc.), an interactive telephonic mode (e.g., automated telephonic interaction, telephonic person-to-person interaction, etc.), an in-person mode (e.g., in-person meetings), or other modality by which a personal health coach, clinician, agent of the health insurance provider, or other individual may communicate with a customer. In one use case, for example, person-to-person online chats may be indicated as the “best” modality for engaging a customer to assist the customer in achieving a targeted change.

In an implementation, personalization subsystem 110 may be programmed to determine scores associated with different modalities of engagement for facilitating a targeted change for a customer. As an example, scores may be determined based on a potential cost savings of the targeted change, respective probabilities of a goal (corresponding to the targeted change) being achieved when the associated modalities are used to facilitate the targeted change, or other criteria.

Upon determination of the scores, personalization subsystem 110 may indicate at least one of the modalities for use in engaging the customer to assist the customer in achieving the corresponding goal based on a comparison of the scores. As an example, an indication (or presentation) of a modality suggested for use in assisting a customer to achieve a corresponding goal may be provided to a coach as the most effective (or impactful) way to assist the customer in achieving the corresponding goal. In another implementation, the selected modality may be presented to the customer so as to guide the customer in helping to select the most effective modality.

As set forth above, a potential cost savings (or value) associated with a targeted change may comprise a monetary or non-monetary cost savings. The potential cost-savings may benefit a health insurance provider that is insuring the customer, a current or prospective employer of the customer, the customer himself, or another entity or individual.

In some implementations, a score may reflect an assessment of a potential reward for achieving a goal (e.g., potential cost savings of a targeted change) and the probabilities of obtaining the reward (e.g., cost savings for the company, cost savings for the customer, or other cost savings resulting from the customer successful implementing the targeted change). Thus, scores may be presented along with suggested modalities of engagement to convey the assessed values (e.g., perceived by users based on the scores) of adopting the system suggestions.

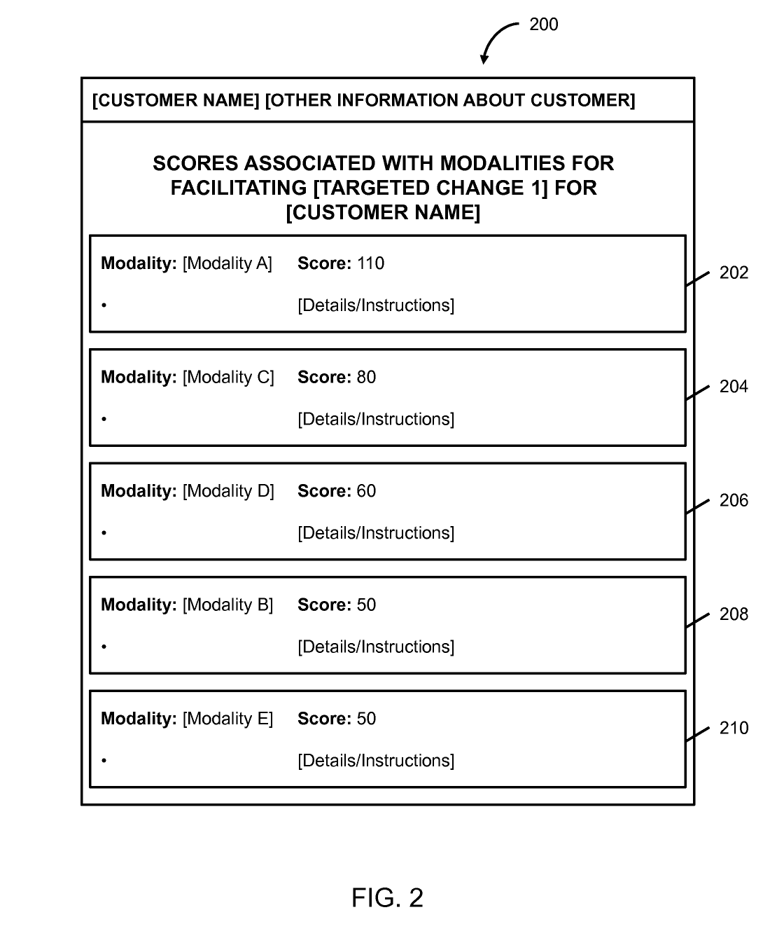

According to an aspect of the invention, as shown in FIG. 2 (and explained in greater detail below), scores associated with different modalities of engagement for facilitating a targeted change of a particular customer may be determined. As an example, user interface 200 depicts associated scores that are determined for different modalities that may be used to facilitate “Targeted Change 1” for the customer.

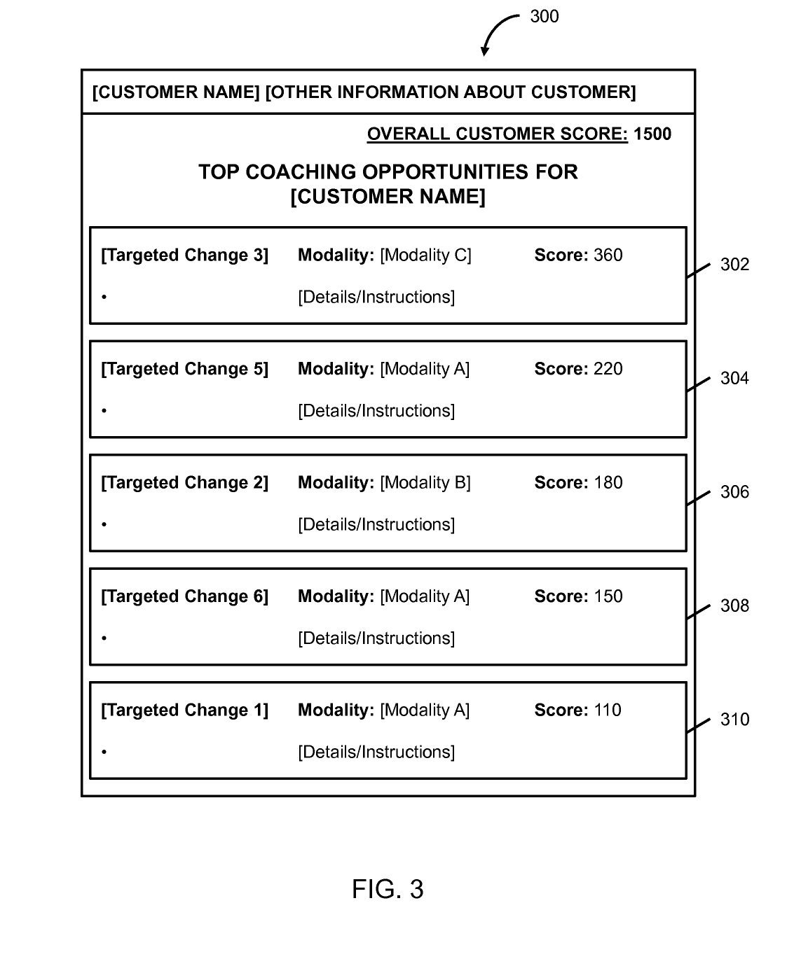

As shown in FIG. 3 (and also explained in greater detail below), user interface 300 depicts the “top coaching opportunities” for a particular customer along with an indication of a suggested modality to use for each when engaging the customer. As an example, Modality C may be indicated as a suggested modality for facilitating “Targeted Change 3” for the customer in lieu of other modalities based on the score associated with Modality C and “Targeted Change 3” (or a corresponding goal thereof) being greater than other scores associated with other modalities and “Targeted Change 3.” Other criteria for selecting a modality for use in facilitating a targeted change may, of course, be implemented.

In an implementation, opportunity subsystem 106 may be programmed to utilize different types of information to proactively “mine” for opportunities for customers. For example, opportunities may be determined for customers based on personal health information associated with the customers (e.g., demographic information, medical diagnoses information, surgical diagnoses information, family diagnoses information, medication information, lab results, etc.), coverage information associated with health plans of the customers (e.g., benefits covered under the health plans, expiration dates of the health plans, deductibles associated with the health plans, co-payments associated with the health plans, healthcare providers covered under the health plans, etc.), activity information associated with the customers (e.g., claims submitted by or on behalf of the customers, purchases of health products or services, etc.), or other information.

In an implementation, opportunity subsystem 106 may be programmed to search a database of potential customer changes to determine one or more targeted changes for a customer. When a first targeted change for the customer is determined, opportunity subsystem 106 may determine opportunities associated with the first targeted change for the customer (e.g., a first potential cost savings associated with the first targeted change). As an example, personal health information, coverage information, or other information associated with a customer may be utilized to determine how much the customer can save in costs (e.g., health care costs based on the customer's health care plan) if the customer adopts a particular targeted change. The potential cost savings may, for example, comprise a potential cost savings over one or more time periods (e.g., potential weekly cost savings, potential monthly cost savings, potential annual cost savings, potential lifetime cost savings, or potential cost savings over other time periods).

In one use case, a targeted change for a customer may comprise the customer switching from purchasing a brand-name medication that the customer currently takes to a generic counterpart. As such, a potential cost savings may comprise a difference in cost between purchasing the brand-name medication and the generic medication. As an example, if the cost of a brand-name medication is $1000 every quarter, and the cost of a generic counterpart is $400 every quarter, a potential cost savings of $600 every quarter for the customer may be determined.

In another use case, a targeted change for a customer may comprise smoking cessation. As an example, profile information associated with the customer may be utilized to determine one or more potential non-monetary effects of the targeted change on the customer (e.g., reduced risk of smoking-related diseases, absence of a need for physician or hospital visits that would have otherwise resulted from the smoking-related diseases, etc.). One or more monetary effects of the targeted change on the customer in the form of potential savings in monetary costs may then be calculated based on the potential non-monetary effects (e.g., potential savings in monetary costs of the customer from the reduced risk of smoking-related diseases, the absence of a need for related physician or hospital visits, etc.).

In other use cases, targeted changes for a customer may comprise a reduction of gaps in care for the customer, an increased adherence of the customer to scheduled medication dosage or usage, a decrease in weight of the customer, or other changes.

In an implementation, profile subsystem 108 may be programmed to manage and/or access profile information associated with a customer. Profile information may comprise identification information, contact information, location information, payment information, personal history information, coverage information, activity information, preference information, or other information. In some implementations, profile subsystem 108 may provide profile information to one or more other subsystems to enable the other subsystems to perform their respective operations. As an example, profile subsystem 108 may provide an identifier associated with a health plan (under which a customer is covered) to opportunity subsystem 106 to enable opportunity subsystem 106 to obtain further coverage information of the customer (e.g., benefits covered under the health plan, an expiration date of the health plan, deductibles associated with the health plan, co-payments associated with the health plan, healthcare providers covered under the health plan, etc.). Opportunity subsystem 106 may then utilize the coverage information to determine whether and/or how much a customer can potentially save in costs (e.g., health care costs based on the customer's current health care plan) if the customer changes a particular behavior or physical aspect of the customer.

In an implementation, opportunity subsystem 106 may be programmed to determine a goal for a customer that corresponds to a targeted change of the customer. In some implementations, one or more predetermined goals may be stored in a database for each change for which customers are targeted. As an example, if multiple goals exist in a database for each targeted change, a goal may be selected from multiple goals corresponding to a targeted change based on one or more criteria. The criteria on which selection of a goal for a customer is based may, for instance, comprise personal health information associated with the customer (e.g., demographic information, medical diagnoses information, etc.), coverage information associated with a health plan of the customer (e.g., benefits covered under the health plan, co-payments associated with the health plan, healthcare providers covered under the health plan, etc.), or other criteria.

In one use case, where a targeted change of a customer comprises the customer switching from purchasing brand-name medications to generic counterparts, one example of a corresponding goal may comprise the customer purchasing only generic medications in lieu of the brand-name counterpart if such generic medications are available. Another example of a corresponding goal may comprise the customer switching at least 50% of his/her purchases of brand-name medications to purchases of generic counterparts.

In a further use case, if multiple goals exist for the targeted change of switching from brand-name to generic medications, a corresponding goal for the customer may be selected from the multiple goals based on coverage information associated with a health plan of the customer (e.g., benefits covered under the health plan, co-payments associated with the health plan, etc.) or other criteria. As an example, a first goal of switching purchases of at least a certain set of brand-name medications to the generic counterparts may be selected over a second goal of switching purchases of all brand-name medications to the generic counterparts (if available) when the second goal would only provide the customer little (if any) additional savings over the first goal. As a result of the customer's healthcare plan, for instance, the second goal (100% switch from brand-name to generic) may not provide the customer with a significant amount of savings over the first goal (switching over a certain set of medications).

In an implementation, personalization subsystem 110 may be programmed to determine one or more probabilities of achieving a goal (that corresponds to a targeted change of a customer) when one or more respective modalities are used to engage the customer. Personalization subsystem 110 may, for instance, determine a first probability of the customer achieving a first goal (that corresponds to a first targeted change) when a first modality of engagement is used, a second probability of the customer achieving the first goal when a second modality of engagement is used, and so on. Personalization subsystem 110 may determine a first score associated with the first modality and the first goal based on the first probability and/or based on a potential cost savings associated with the targeted change. Personalization subsystem 100 may also determine a second score associated with the second modality and the first goal based on second probability and/or based on the potential cost savings, and so on. The scores may then be utilized to generate a display that conveys at least one of the modalities for facilitating the targeted change.

In one scenario, with respect to FIG. 3, a score associated with Modality C and a goal corresponding to “Targeted Change 3” may be calculated based on a potential cost savings associated with “Targeted Change 3” and based on a probability of a customer achieving the corresponding goal when Modality C is used to engage the customer. As an example, it may be determined that a customer can save up to $720 annually by switching from purchasing brand-name medications to purchasing available generic counterparts. A goal corresponding to such a targeted change may comprise switching all purchases of brand-name medications that the customer currently takes to their corresponding generic counterparts (e.g., a 100% switch). A probability of the customer achieving the corresponding goal may be determined to be 50%. Probability determination is explained in greater detail below. As such, a score of 360 for Modality C and the corresponding goal may be based on the potential cost savings (e.g., $720), an extent of the corresponding goal (e.g., 100% switch), and the probability of achievement (e.g., 50%), where the score of 360=720*1.00*0.50. Other scores, potential cost savings, extent of goals, or probabilities may, of course, be utilized and/or determined.

In a further scenario, with respect to FIG. 3, a score associated with Modality A and a goal corresponding to “Targeted Change 5” may be calculated based on a potential cost savings associated with “Targeted Change 5” and based on a probability of the customer (indicated in user interface 300) achieving the corresponding goal when Modality A is used to engage the customer. Scores associated with the other modalities and corresponding goals of targeted changes depicted in FIG. 3 may be calculated in a similar manner. Other approaches may, of course, be implemented to calculate scores associated with modalities and/or goals.

In another scenario, with respect to FIG. 2, the user interface 200 may display actionable areas 202-210 based on calculated scores (e.g., associated with the respective modalities). As an example, the actionable areas 202-210 may be arranged on the user interface 200 (e.g., arranged in a certain order, arranged in particular locations, etc.) based on the calculated scores (e.g., an actionable area with the highest score may be listed before other actionable areas). In one use case, the actionable areas 202-210 may comprise actionable buttons or other interface items that may be activated (e.g., via a touch, hold, click, or other activation technique) to initiate one or more actions related to the respective actionable areas 202-210 (e.g., actions related to the specific modality and targeted change associated with an actionable area). The actions (that may be initiated by activating an actionable interface item) may comprise causing an automated interactive session related to a corresponding targeted change to be activated for the customer (e.g., activating an automated web, telephonic, or other interaction that guides the customer toward the targeted change), initiating scheduling of an initial session or series of sessions with the customer for a corresponding targeted change (e.g., sending a message to the customer with one or more selectable dates/times for the initial chat, telephonic, in-person, or other sessions), or other actions. In another use case, the action areas 202-210 (or portions thereof) may themselves be activated (e.g., via a touch, hold, click, or other activation technique) to initiate one or more actions related to the respective actionable areas 202-210.

In yet another scenario, with respect to FIG. 3, the user interface 300 may display actionable areas 302-310 based on calculated scores (e.g., associated with the respective modalities). As an example, the actionable areas 302-310 may be arranged on the user interface 300 (e.g., arranged in a certain order, arranged in particular locations, etc.) based on the calculated scores (e.g., an actionable area with the highest score may be listed before other actionable areas). Similar to the foregoing use cases with respect to FIG. 3, the actionable areas 302-310 may comprise actionable buttons or other interface items that may be activated (e.g., via a touch, hold, click, or other activation technique) to initiate one or more actions related to the respective actionable areas 302-310, or may themselves be activated to initiate one or more actions related to the respective actionable areas 302-310.

In an implementation, personalization subsystem 110 may be programmed to select at least one modality (e.g., from among multiple modalities) for use in engaging a customer to assist the customer in achieving a goal that corresponds to a targeted change of the customer. The selection of the modality may, for instance, be based on a comparison of scores associated with the multiple modalities, respectively (e.g., a higher-scored modality may be selected over a lower-scored modality, a lower-scored modality may be selected over a higher-scored modality, etc.). Upon selection of the modality, personalization subsystem 110 may generate a display that conveys the selected modality for facilitating the targeted change.

Probabilities of a Customer Achieving a Goal

In certain implementations, a probability of a customer achieving a first goal (corresponding to a first targeted change of the customer) may be determined based on whether the customer or other customers have achieved related goals. Information regarding the achievements (or lack thereof) of customers may be stored at one or more databases. Thus, such information may be obtained from the databases to assess probabilities of customers achieving one or more goals.

In one use case, with respect to FIG. 2, a first probability of a customer achieving a goal (corresponding to “Targeted Change 1”) when Modality A is used to engage the customer may be determined based on whether the customer or other customers have achieved related goals when Modality A was used to engage the customer or other customers to assist in achieving the related goals. A second probability of the customer achieving the corresponding goal when Modality B is used to engage the customer (to assist in achieving the corresponding goal) may be determined based on whether the customer or other customers have achieved the related goals when Modality B was used to engage the customer or other customers to assist in achieving the related goals, and so on.

In one implementation, a probability of a customer achieving a goal (corresponding to a targeted change) may be determined based on whether one or more other customers similar to the customer achieved a related goal. In some implementations, progress monitoring subsystem 112 may determine whether the similar customers achieved the goal corresponding to the targeted change when respective modalities were used to assist the similar customers in achieving the goal. If so, progress monitoring subsystem 112 may then determine a probability of the customer achieving the goal based on whether the similar customers achieved the goal and based on the respective modalities. As an example, if 50% of other customers similar to a particular customer achieved a goal corresponding to a given targeted change when a first modality was used to assist the similar customers in achieving the goal, progress monitoring subsystem 112 may determine that the probability of the customer achieving the goal is 50% when the first modality is used to assist the customer for the goal. Other approaches and/or other probabilities may, of course, be utilized and/or determined.

In an implementation, a probability of a customer achieving a goal (corresponding to a targeted change) may be determined based on whether the customer himself achieved a related goal. In some implementations, progress monitoring subsystem 112 may determine whether the customer achieved related goals (corresponding to changes related to the targeted change) when respective modalities were used to assist the customer in achieving the related goals. The related changes may, for example, comprise changes that were previously targeted for the customer. If so, progress monitoring subsystem 112 may then determine the probability of the customer achieving the goal based on whether the customer achieved the related goals and based on the respective modalities. As an example, if the customer achieved 50% of the related goals when a first modality was used to assist the customer in achieving the related goals, progress monitoring subsystem 112 may determine that the probability of the customer achieving the goal (corresponding to the targeted change) is 50% when the first modality is used to assist the customer for the goal. Other approaches and/or other probabilities may, of course, be utilized and/or determined.

Overall Score Associated with a Customer

In certain implementations, an overall score associated with a customer may be determined based on scores associated with modalities and targeted changes (or corresponding goals thereof) of the customer.

Overall scores of customers may, for example, be utilized to identify the customers for which targeted changes should be prioritized. As an example, customers associated with higher overall scores may indicate that the value of assisting those customers in implementing their targeted changes (or corresponding goals thereof) is greater than the value of assisting other customers (associated with lower overall scores) in implementing their targeted changes. As discussed above, in some scenarios, scores associated with modalities and targeted changes may reflect an assessment of potential rewards for achieving respective goals (e.g., potential cost savings of respective targeted changes) and the probabilities of obtaining the rewards (e.g., cost savings for the company, cost savings for the customer, or other cost savings resulting from the customer successful implementing the targeted change).

In an implementation, personalization subsystem 110 may be programmed to determine, for each targeted change of a customer, the highest score from a set of scores associated with modalities and the targeted change (or a corresponding goal thereof) to obtain a set of highest scores. Personalization subsystem 110 may then generate an overall score associated with the customer based on the set of highest scores.

In one use case, as shown in FIG. 3, user interface 300 may depict an overall score of a customer (e.g., an overall score of 1500). If, for example, there are 10 targeted changes (e.g., Targeted Changes 1-10), the highest score associated with the modalities for each of the targeted changes may be summed to obtain the overall score of 1500. As an example, each of the scores shown in user interface 300 may comprise the highest score associated with modalities for each of the depicted targeted changes (e.g., Targeted Changes 1-3, 5, and 6). The sum of the highest scores for the remaining 5 targeted changes that are not shown in user interface 300 (e.g., Targeted Changes 4 and 7-10) may be 480. As such, the respective high scores of 360, 220, 180, 150, and 110 may be summed together with the immediate result of 480 to obtain the overall score of 1500 for the customer.

Exemplary Flowcharts

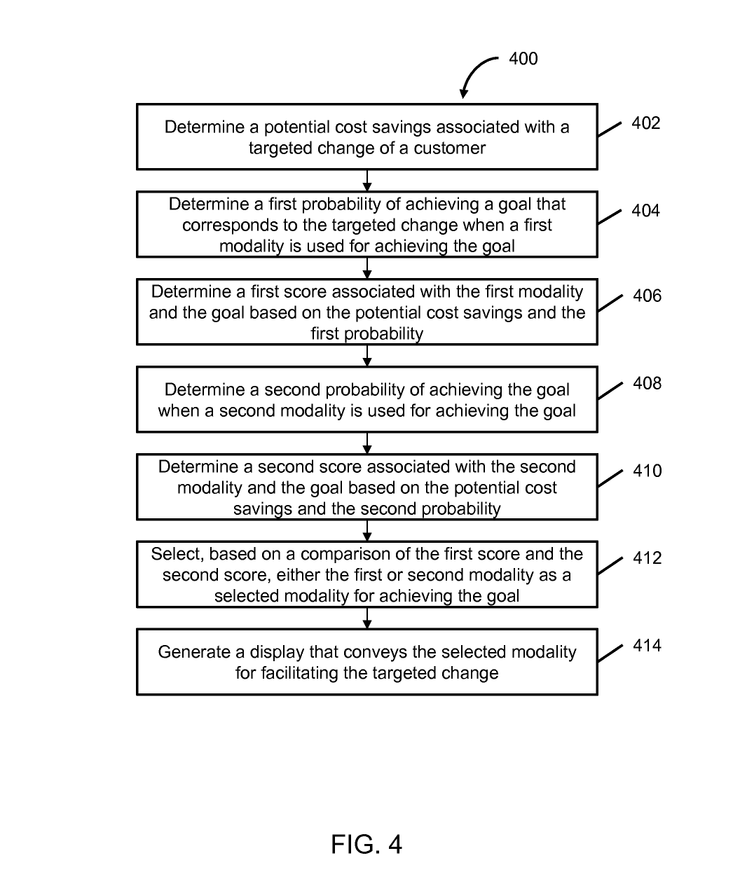

FIGS. 4-6 comprise exemplary illustrations of flowcharts of processing operations of methods that enable the various features and functionality of the system as described in detail above. The processing operations of each method presented below are intended to be illustrative and non-limiting. In some implementations, for example, the methods may be accomplished with one or more additional operations not described, and/or without one or more of the operations discussed. Additionally, the order in which the processing operations of the methods are illustrated (and described below) is not intended to be limiting.

In some implementations, the methods may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the methods in response to instructions stored electronically on an electronic storage medium. The one or more processing devices may include one or more devices configured through hardware, firmware, and/or software to be specifically designed for execution of one or more of the operations of the methods.

FIG. 4 is an exemplary illustration of a flowchart of a method 400 of providing indications of modalities for targeted customer changes, according to an aspect of the invention.

In an operation 402, a potential cost savings associated with a targeted change of a customer may be determined. As an example, profile information associated with the customer may be utilized to determine one or more potential non-monetary effects of the targeted change on the customer (e.g., reduced emergency hospital visits, decreased need for medication, etc.). One or more monetary effects of the targeted change on the customer in the form of potential savings in monetary costs of the customer may then be calculated based on the potential non-monetary effects (e.g., potential savings in monetary costs of the customer from a particular reduction emergency hospital visits, a particular decrease in medication need, etc.). Operation 402 may be performed by an opportunity subsystem that is the same as or similar to opportunity subsystem 106, in accordance with one or more implementations.

In an operation 404, a first probability of achieving a goal (that corresponds to the targeted change) when a first modality is used to assist in achieving the goal may be determined. As an example, the first probability may comprise a probability of the customer achieving the goal when the first modality is used to engage the customer to assist the customer in achieving the goal. Operation 404 may be performed by a personalization subsystem that is the same as or similar to personalization subsystem 110, in accordance with one or more implementations.

In an operation 406, a first score associated with the first modality and the goal (that corresponds to the targeted change) may be determined based on the potential cost savings and the first probability. Operation 406 may be performed by a personalization subsystem that is the same as or similar to personalization subsystem 110, in accordance with one or more implementations.

In an operation 408, a second probability of achieving the goal (that corresponds to the targeted change) when a second modality is used to assist in achieving the goal may be determined. As an example, the second probability may comprise a probability of the customer achieving the goal when the second modality is used to engage the customer to assist the customer in achieving the goal. Operation 408 may be performed by a personalization subsystem that is the same as or similar to personalization subsystem 110, in accordance with one or more implementations.

In an operation 410, a second score associated with the second modality and the goal (that corresponds to the targeted change) may be determined based on the potential cost savings and the second probability. Operation 410 may be performed by a personalization subsystem that is the same as or similar to personalization subsystem 110, in accordance with one or more implementations.

In an operation 412, either the first modality or the second modality may be selected as a selected modality to assist in achieving the goal (that corresponds to the targeted change) based on a comparison of the first score and the second score. As an example, where a higher score reflects a better score, the first modality may be selected as a selected modality for use in engaging the customer to assist the customer in achieving the goal in response to a determination that the first score is greater than the second score. As another example, where a lower score reflects a better score, the first modality may be selected as the selected modality in response to a determination that the first score is less than the second score. Operation 412 may be performed by a personalization subsystem that is the same as or similar to personalization subsystem 110, in accordance with one or more implementations.

In an operation 414, a display that conveys the selected modality for facilitating the targeted change may be generated. As an example, the display (conveying the selected modality for facilitating the targeted change) may be provided to a coach to guide the coach in assisting the customer to achieve the goal. As another example, the display may be provided to the customer to guide the customer in selecting a modality through which support is to be provided. Operation 414 may be performed by a personalization subsystem that is the same as or similar to personalization subsystem 110, in accordance with one or more implementations.

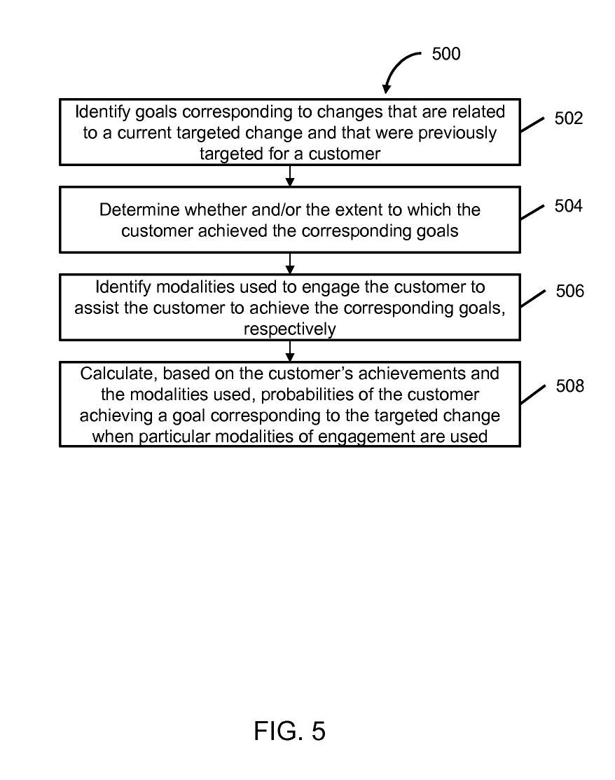

FIG. 5 is an exemplary illustration of a flowchart of a method 500 of determining probabilities of a customer achieving a goal corresponding to a targeted change when particular modalities of engagement are used based on whether the customer achieved corresponding goals of related changes that were previously targeted for the customer, according to an aspect of the invention.

In an operation 502, one or more goals corresponding to one or more changes may be identified. The changes may, for example, be related to a current targeted change and may have been previously targeted for a customer. Operation 502 may be performed by an opportunity subsystem that is the same as or similar to opportunity subsystem 106, in accordance with one or more implementations.

In an operation 504, a determination of whether the customer achieved the corresponding goals may be effectuated. Operation 504 may be performed by a progress monitoring subsystem that is the same as or similar to progress monitoring subsystem 112, in accordance with one or more implementations.

In an operation 506, modalities used to engage the customer to assist the customer to achieve the corresponding goals, respectively, may be determined. As an example, a first modality of engagement that was used to assist the customer in achieving a first goal corresponding to a first previously-targeted change may be determined. A second modality of engagement that was used to assist the customer in achieving a second goal corresponding to a second previously-targeted change may also be determined, and so on. Operation 506 may be performed by a personalization subsystem that is the same as or similar to personalization subsystem 110, in accordance with one or more implementations.

In an operation 508, probabilities of the customer achieving a goal (corresponding to the current targeted change) when particular modalities of engagement are used may be determined based on the customer's achievements (and/or lack thereof) and based on the modalities that were used to assist in the customer's achievements (and/or lack thereof). Operation 508 may be performed by a personalization subsystem that is the same as or similar to personalization subsystem 110, in accordance with one or more implementations.

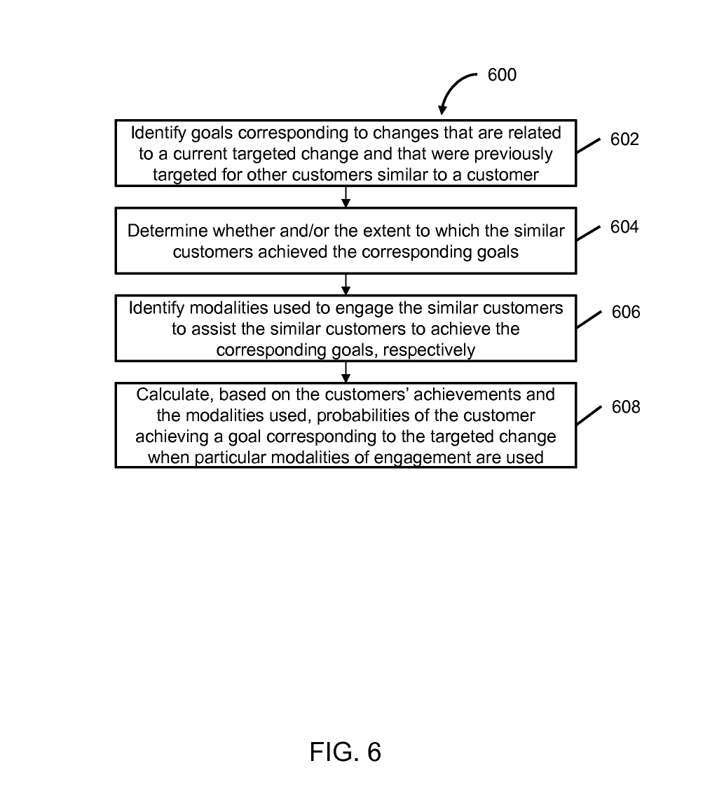

FIG. 6 is an exemplary illustration of a flowchart of a method 600 of determining probabilities of a customer achieving a goal corresponding to a targeted change when particular modalities of engagement are used based on whether other customers similar to the customer achieved corresponding goals of related changes that were previously targeted for the similar customers, according to an aspect of the invention.

In an operation 602, one or more goals corresponding to one or more changes may be identified. As an example, the changes may be related to a current targeted change and may have been previously targeted for one or more other customers similar to a customer (for which the current change is targeted). As another example, the changes previously targeted for the similar customers may comprise the change currently targeted for the customer. Operation 602 may be performed by an opportunity subsystem that is the same as or similar to opportunity subsystem 106, in accordance with one or more implementations.

In an operation 604, a determination of whether the similar customers achieved the corresponding goals may be effectuated. As an example, a determination of whether the similar customers previously achieved the change currently targeted for the customer may be effectuated. Operation 604 may be performed by a progress monitoring subsystem that is the same as or similar to progress monitoring subsystem 112, in accordance with one or more implementations.

In an operation 606, modalities used to engage the customer to assist the similar customers to achieve the corresponding goals, respectively, may be determined. As an example, a first modality of engagement that was used to assist a first similar customer in achieving a goal corresponding to a previously-targeted change may be determined. A second modality of engagement that was used to assist a second similar customer in achieving the goal corresponding to the previously-targeted change may also be determined, and so on. Operation 606 may be performed by a personalization subsystem that is the same as or similar to personalization subsystem 110, in accordance with one or more implementations.

In an operation 608, probabilities of the customer achieving a goal (corresponding to the current targeted change) when particular modalities of engagement are used may be determined based on the similar customers' achievements (and/or lack thereof) and based on the modalities that were used to assist in the similar customers' achievements (and/or lack thereof). Operation 608 may be performed by a personalization subsystem that is the same as or similar to personalization subsystem 110, in accordance with one or more implementations.

Although the present invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any implementation can be combined with one or more features of any other implementation.

What is claimed is:

1. A method of providing indications of modalities for targeted customer changes, the method being implemented on a computer system that includes one or more physical processors which, when executed, perform the method, the method comprising:
determining, by the computer system, a first potential cost savings associated with a first targeted change of a customer;
determining, by the computer system, a first probability of achieving a first goal that corresponds to the first targeted change when a first modality is used to engage the customer to assist the customer in achieving the first goal;
determining, by the computer system, a first score associated with the first modality and the first goal based on the first potential cost savings and the first probability;
determining, by the computer system, a second probability of achieving the first goal that corresponds to the first targeted change when a second modality is used to engage the customer to assist the customer in achieving the first goal, wherein the second modality is different than the first modality;
determining, by the computer system, a second score associated with the second modality and the first goal based on the first potential cost savings and the second probability;
selecting, by the computer system, based on a comparison of the first score and the second score, either the first modality or the second modality as a selected modality for use in engaging the customer to assist the customer in achieving the first goal; and
generating, by the computer system, a display that conveys the selected modality for facilitating the first targeted change.

2. The method of claim 1, wherein the first targeted change comprises at least one of a behavior change of the customer or a physical change of the customer.

3. The method of claim 1, wherein selecting either the first modality or the second modality as the selected modality comprises either: (1) determining that the first score is greater than the second score; or (2) determining that the second score is greater than the first score.

4. The method of claim 1, further comprising:
determining, by the computer system, a second potential cost savings associated with a second targeted change of the customer;
determining, by the computer system, a third probability of achieving a second goal that corresponds to the second targeted change when a third modality is used to engage the customer to assist the customer in achieving the second goal; and
determining, by the computer system, a third score associated with the third modality and the second goal based on the second potential cost savings and the second probability, wherein generating the display comprises generating a display that conveys the first modality and the third modality as selected modalities for facilitating the first targeted change and second targeted change, respectively.

5. The method of claim 1, further comprising:
determining, by the computer system, one or more customers that have been previously targeted for a change related to the first targeted change; and
determining, by the computer system, whether the one or more customers achieved a goal that corresponds to a change related to the first targeted change,
wherein determining the first probability comprises determining the first probability based on the determination of whether the one or more customers achieved a goal that corresponds to a change related to the first targeted change.

6. The method of claim 5, wherein the one or more customers comprise the customer, and wherein determining whether the one or more customer achieved a goal that corresponds to a change related to the first targeted change comprises determining whether the customer achieved a goal that corresponds to a change related to the first targeted change.

7. The method of claim 5, wherein the one or more customers comprise at least one other customer different than the customer, and wherein determining whether the one or more customer achieved a goal that corresponds to the first targeted change comprises determining whether the at least one other customer achieved a goal that corresponds to the first targeted change.

8. The method of claim 5, wherein determining the one or more customers comprises determining one or more other customers similar to the customer that have been previously targeted for the first targeted change, and
wherein determining whether the one or more customer achieved a goal that corresponds to the first targeted change comprises determining whether the one or more other similar customers achieved a goal that corresponds to the first targeted change.

9. A system for providing indications of modalities for targeted customer changes, the system comprising:
one or more physical processors programmed to execute computer program instructions which, when executed, cause the one or more physical processors to:
determine a first potential cost savings associated with a first targeted change of a customer;
determine a first probability of achieving a first goal that corresponds to the first targeted change when a first modality is used to engage the customer to assist the customer in achieving the first goal;
determine a first score associated with the first modality and the first goal based on the first potential cost savings and the first probability;
determine a second probability of achieving the first goal that corresponds to the first targeted change when a second modality is used to engage the customer to assist the customer in achieving the first goal, wherein the second modality is different than the first modality;
determine a second score associated with the second modality and the first goal based on the first potential cost savings and the second probability;
select, based on a comparison of the first score and the second score, either the first modality or the second modality as a selected modality for use in engaging the customer to assist the customer in achieving the first goal; and
generate a display that conveys the selected modality for facilitating the first targeted change.

10. The system of claim 9, wherein the first targeted change comprises at least one of a behavior change of the customer or a physical change of the customer.

11. The system of claim 9, wherein selecting either the first modality or the second modality as the selected modality comprises either: (1) determining that the first score is greater than the second score; or (2) determining that the second score is greater than the first score.

12. The system of claim 9, wherein the one or more physical processors are further caused to:
determining, by the computer system, a second potential cost savings associated with a second targeted change of the customer;
determining, by the computer system, a third probability of achieving a second goal that corresponds to the second targeted change when a third modality is used to engage the customer to assist the customer in achieving the second goal; and
determining, by the computer system, a third score associated with the third modality and the second goal based on the second potential cost savings and the second probability,
wherein generating the display comprises generating a display that conveys the first modality and the third modality as selected modalities for facilitating the first targeted change and second targeted change, respectively.

13. The system of claim 9, wherein the one or more physical processors are further caused to:
determining, by the computer system, one or more customers that have been previously targeted for a change related to the first targeted change; and
determining, by the computer system, whether the one or more customers achieved a goal that corresponds to a change related to the first targeted change, wherein determining the first probability comprises determining the first probability based on the determination of whether the one or more customers achieved a goal that corresponds to a change related to the first targeted change.

14. The system of claim 13, wherein the one or more customers comprise the customer, and wherein determining whether the one or more customer achieved a goal that corresponds to a change related to the first targeted change comprises determining whether the customer achieved a goal that corresponds to a change related to the first targeted change.

15. The system of claim 13, wherein the one or more customers comprise at least one other customer different than the customer, and wherein determining whether the one or more customer achieved a goal that corresponds to the first targeted change comprises determining whether the at least one other customer achieved a goal that corresponds to the first targeted change.

16. The system of claim 13, wherein determining the one or more customers comprises determining one or more other customers similar to the customer that have been previously targeted for the first targeted change, and
wherein determining whether the one or more customer achieved a goal that corresponds to the first targeted change comprises determining whether the one or more other similar customers achieved a goal that corresponds to the first targeted change.
